(19) United States
(12) Patent Application Publication
(10) Pub. No.: US 2005/0048270 A1
(43) Pub. Date: Mar. 3, 2005

(54) System and method of advertising with a bathroom fixture

(76) Inventor: Andrew Prince, Calgary (CA)

Correspondence Address: STEPHEN J. LEWELLYN, 933 OLEANDER WAY SOUTH, SUITE 3, SOUTH PASADENA, FL, 33707, US

(21) Appl. No.: 10/929,713

(22) Filed: Aug. 30, 2004

Related U.S. Application Data
(60) Provisional application No. 60/498,576, filed on Aug. 29, 2003.

(51) Int. Cl. B32B 3/00

(52) U.S. Cl. 428/195.1

(57) ABSTRACT

A novel system and method of bathroom fixture advertising is provided. The system comprises a bathroom fixture, advertising material secured to the fixture's surface and a gloss applied over the advertising material and part of the adjacent surface. The method comprises the steps of applying the advertising material to the surface, applying a bonding agent to the advertising material and the adjacent surface, and applying a coat of gloss over the advertising material and the adjacent surface. A method for sequentially displaying different advertisements is also provided; the method comprising the steps of placing the advertising material on a bathroom fixture, displaying the advertising material for a predetermined amount of time, removing the fixture from the bathroom and replacing it with a new fixture, determining whether another advertisement will be displayed, and, if so, repeating the steps of this method.

### CROSS-REFERENCE TO RELATED APPLICATION

This application claims the benefit of U.S. Provisional Application No. 60/498576, filed Aug. 29, 2003, the entirety of which is incorporated herein by reference.

### FIELD OF THE INVENTION

The present invention relates generally to a system and method of advertising, and more particularly to a system and method of advertising utilizing bathroom or restroom fixtures.

### BACKGROUND OF THE INVENTION

Advertisers of goods and services are constantly searching for the so called “captive audience”, where a member of a potential consumer group is placed in such a way so that he or she can hardly avoid exposure to the advertisement directed at them. For example, motorists are constantly subjected to billboard advertising and grocery shoppers are exposed to advertisements strategically placed on grocery carts. However, in today's competitive commercial market, there exists a need to provide additional outlets for advertising. In addition, there exists a need to provide additional outlets for advertising to a captive audience in a bathroom, restroom or similar setting without distraction from the comfortable and private mood of such a setting.

The use of fixtures, such as toilets, urinals, sinks, and bathtubs, in bathrooms, restrooms and other settings is known in the prior art. While these fixtures fulfill their respective objectives, they do not provide a new method of advertising. Therefore, there exists a further need to present advertisement to consumers using such fixtures.

### SUMMARY OF THE INVENTION

It is an object of the present invention to provide additional outlets for advertising.

It is a further objective of the present invention to provide a system for presenting advertisement material to individuals in a bathroom or similar setting, by using bathroom fixtures, and without distracting from the comfortable mood inherent in such settings.

The present invention accomplishes these objects by providing a system of advertising. The system comprises advertising material, such as logo indicia or decals, securely placed on the surface of bathroom fixtures. The present invention further accomplishes these objects by providing multiple embodiments of a method for securely placing advertising material on a bathroom fixture. The invention also provides multiple embodiments of a method of sequentially displaying different advertisements in a bathroom.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1a is a schematic perspective view of a new system of advertising utilizing the surface of bathroom fixtures to securely support advertising material;

FIGS. 1b and 1c are schematic perspective views of bathroom fixtures with advertising material securely placed upon their respective surfaces;

FIG. 2 is a flow chart of one embodiment of a method for securely placing advertising material on a bathroom fixture;

FIG. 3 is a flow chart of another embodiment of a method for securely placing advertising material on a bathroom fixture;

FIG. 4 is a flow chart of one embodiment of a method for sequentially displaying different advertisements in a bathroom; and

FIG. 5 is a flow chart of another embodiment of a method for sequentially displaying different advertisements in a bathroom.

The same reference numerals refer to the same parts throughout the various figures.

### DETAILED DESCRIPTION OF THE INVENTION

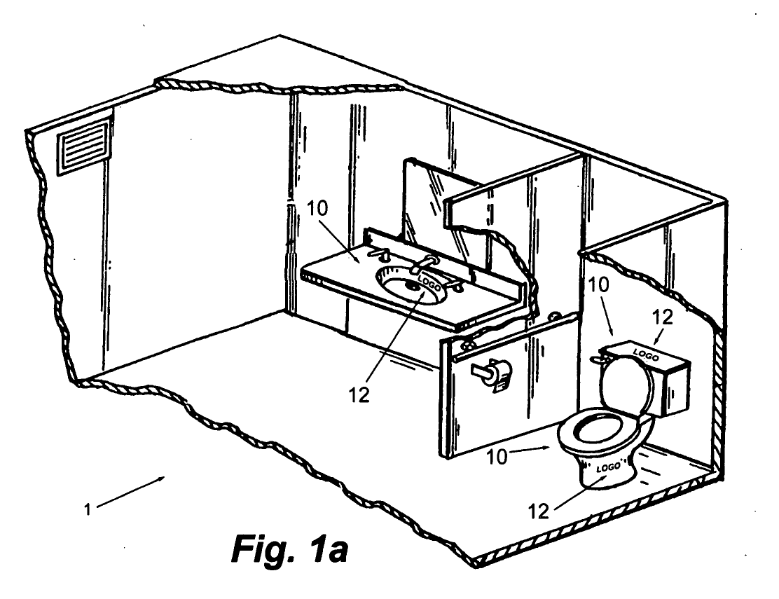

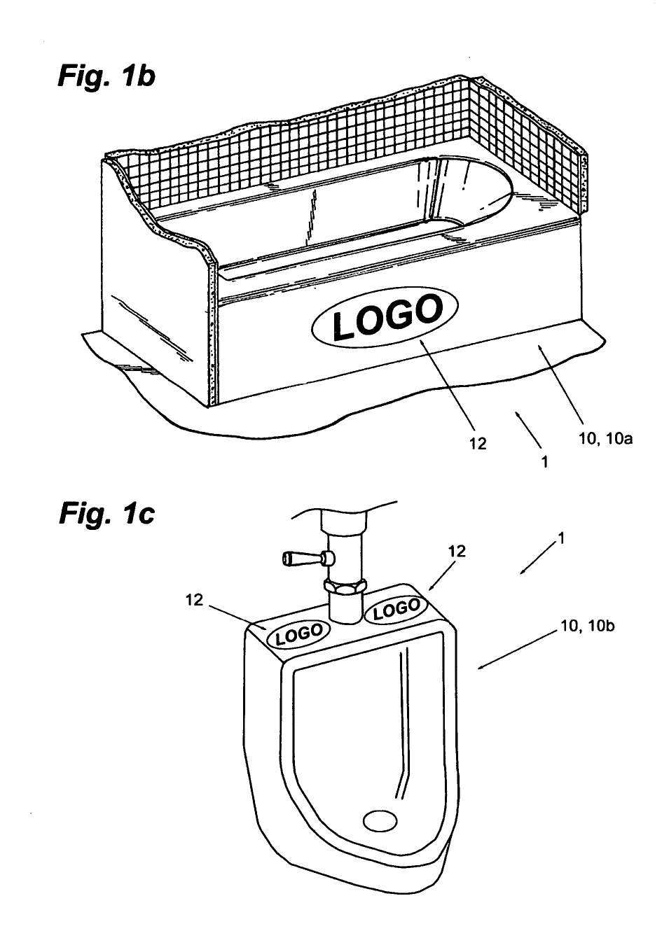

Referring to FIGS. 1a-1c, a new system of advertising 1, incorporating existing bathroom fixtures 10, such as toilets, washbasins, and sinks, is shown in (FIG. 1). Suitable bathroom or restroom fixtures 10 include those made from porcelain, fiberglass, enameled steel, marble, cultured marble, tile, and Corian™ which is manufactured by E.I. Du Pont De Nemours Company of Wilmington, Del., USA. The system of advertising 1 comprises advertising material 12, such as logo indicia or decals, securely placed on the surfaces of bathroom fixtures 10. FIGS. 1b and 1c illustrate that other types of bathroom fixtures, such as bathtubs 10a and urinals 10b, may also be used by the system 1.

Typically, the bathroom fixture 10 will be those of distinct bathrooms or restrooms, such as those in hotels, restaurants, bars, gas stations, public restroom facilities and the like (see FIG. 1a). However, bathroom fixtures with advertising material 12 may also be part of a multi-function room, such as in motel rooms where wash basins may be presented in a corner of the main bedroom.

However, since bathroom fixtures 10 are often exposed to various cleaning liquids, moisture, water and other liquids, care must be taken when placing the advertising material 12 on the surface of a bathroom fixture 10 so as to make certain that the advertising material is securely placed on the surface of the bathroom fixture.

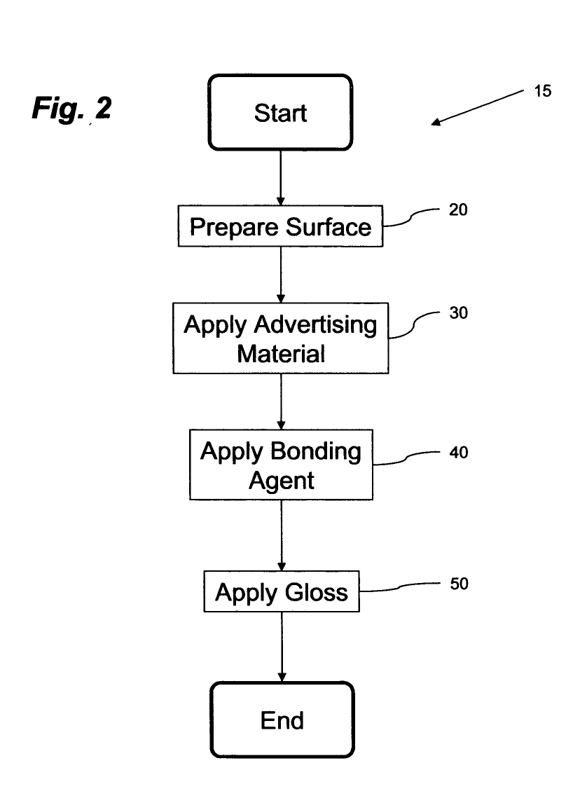

Referring to FIG. 2, one embodiment of a method 15 for securely placing advertising material on a bathroom fixture is shown. First the surface of the bathroom fixture is prepared 20 to accept the advertising material. In this embodiment, the preparation 20 comprises both cleaning the surface with an acidified cleaner and degreasing the surface with a silicone wash to remove any traces of grease or silicone from the surface. A suitable acidified cleaner is the Fire Wash™ cleaner distributed by Covenant Restorations & Renovations of Calgary, Alberta, Canada, although other acidified cleaners and silicone washes can be used. In another embodiment, not shown, and where the surface of the fixture is clean enough to accept the advertising material, the preparation step can be 14 omitted, with the rest of the method proceeding as described in the following two paragraphs.

Next, the advertising material is applied 30 to the bathroom fixture surface, preferably using a suitable adhesive. Typically, the advertising material is a plastic-based decal featuring a logo or other advertising indicia. Once the advertising material is put on the fixture's surface, a bonding agent is applied 40 to the advertising material and surrounding surface. The bonding agent allows gloss to be applied subsequently to adhere to the fixture's surface. Preferably, the bonding agent is put on using a clean cloth and is applied evenly over the top of the decal and surrounding surface.

Finally, a gloss is applied 50 to the advertising material and the surrounding fixture's surface. Preferably, the gloss is applied using a specialized paint sprayer such as an air gun. A suitable gloss can be obtained by mixing 3 parts high gloss clear BX00, 1 part catalyst BX00 and 1 part spot repair thinner HR03; all three products are distributed by Covenant Restorations & Renovations of Calgary, Alberta, Canada. The gloss will from a clear coat over the advertising material and surrounding surface thereby providing protection to the advertising material from subsequent exposure to various cleaning liquids, moisture, water and other liquids; and thus preventing the advertising material from pealing or washing off from the fixture's surface. A typical drying time for the gloss, as described above, is about 24 hours. A typical curing time for such a gloss is 8 days.

This method is particularly suitable if different advertising material is to be displayed only for a matter of days and exposure of the fixture to various cleaning liquids, moisture, water and other liquids is minimal; because it allows for an easier subsequent removal of the advertising material from the fixture.

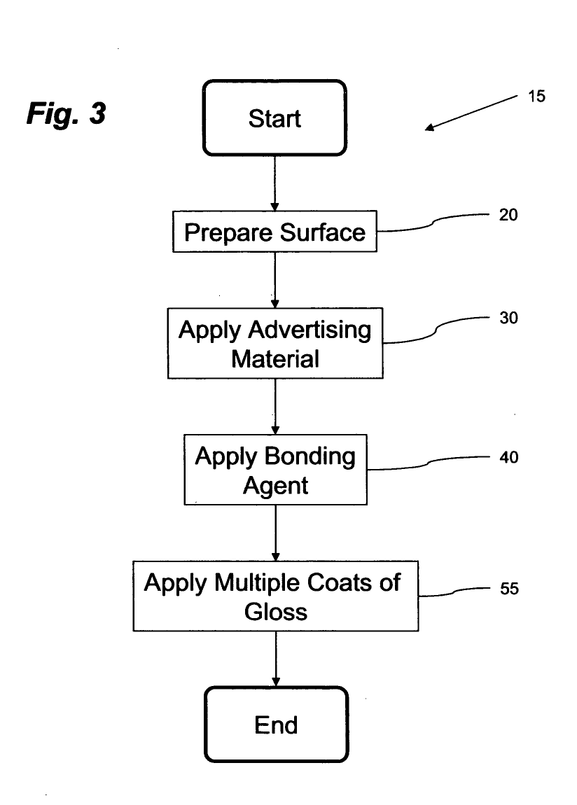

FIG. 3 illustrates another embodiment of placing 15 the advertising material on a bathroom fixture. In this embodiment, the first three steps of preparing the surface 20, applying the advertising material 30 and applying the bonding agent 40 are identical to those as discussed above for FIG. 2. However, to ensure for a much more permanent placement of the advertising material to the fixture's surface, the fourth step comprises applying multiple coats of gloss 55. Preferably, forty individual coats of gloss are applied at 15 minute intervals. A typical curing time for such a gloss is 8 days.

This Method is particularly suitable if different advertising material is displayed for months at time and exposure of the fixture to various cleaning liquids, moisture, water and other liquids is high; because it provided additional coats of gloss and extra protection to the underlying advertising material.

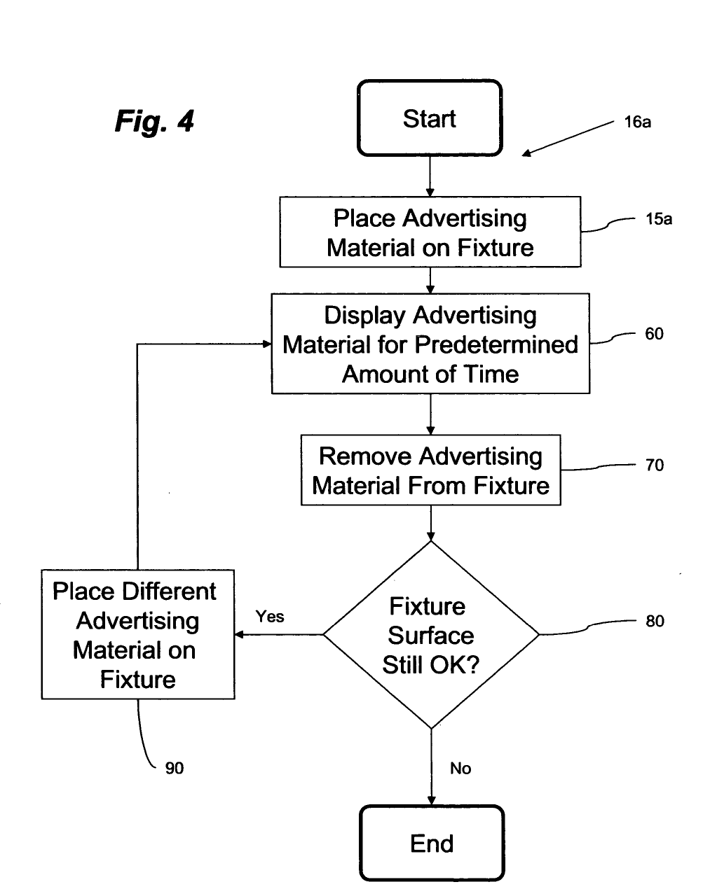

Now referring to FIG. 4, one embodiment of a method for sequentially displaying different advertisements in a bathroom is shown. The method comprises placing 15 the advertising material on a fixture, displaying 60 the advertising material for a predetermined amount of time, removing 70 the advertising material from the fixture, determining 80 whether the fixture's surface is still okay to accept subsequent placements of advertising material, and is so, placing 90 different advertising material on the fixture, and repeating the second through sixth steps (60 through 90) until the surface is not okay. Removal 70 of the advertising material can be done via mechanical means, such as through scraping off the advertising material with a scraper. This method is particularly suitable if the method of FIG. 2 was used to place the advertising material on the fixture; because only one coat of gloss needs to be removed or scrapped off.

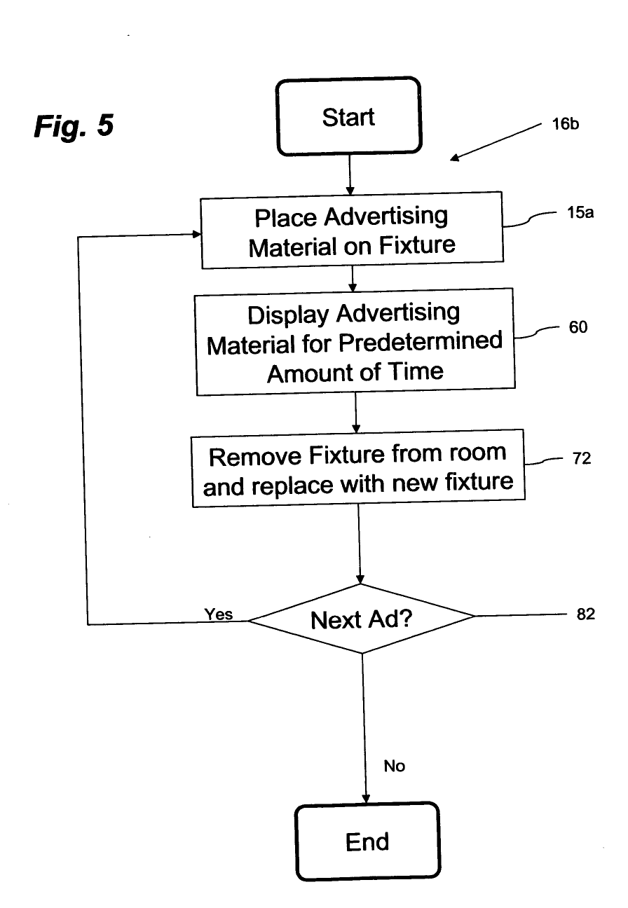

FIG. 5 illustrates another embodiment of a method of sequentially displaying different advertisements in a bathroom. This method comprises placing 15 the advertising material on the fixture, displaying 60 the advertising material for a predetermined amount of time, removing 72 the fixture from the bathroom and replacing it with a new fixture of the same type, determining 80 whether another advertisement will be displayed on the fixture, and, if so, repeating the second through fifth steps (60 through 82). Removal of the advertising material from a fixture is not done in this embodiment and instead the fixture itself, along with the advertising material thereupon, is simply replaced with a new fixture. This method is particularly suitable if the method of FIG. 3 was used to place the advertising material on the fixture; because multiple coats of gloss would need to be removed or scrapped off which may result in significant labor costs.

A number of embodiments of the present invention have been described. Nevertheless, it will be understood that various modifications may be made without departing from the spirit and scope of the invention. Accordingly, other embodiments are within the scope of the following claims.

1. A bathroom fixture advertising system, comprising:
a bathroom fixture having a surface;
advertising material secured to said surface; and
a coat of gloss applied over said advertising material and said surface adjacent said advertising material.

2. The bathroom fixture advertising system of claim 1, wherein said advertising material is a plastic-based decal.

3. The bathroom fixture advertising system of claim 2, wherein said plastic-based decal has an adhesive backed surface.

4. The bathroom fixture advertising system of claim 1, wherein said gloss comprises:
three parts high gloss clear;
one part catalyst; and
one part thinner.

5. The bathroom fixture advertising system of claim 1, further comprising:
a bonding agent applied between said coat of gloss and said surface.

6. A method of displaying an advertisement on a bathroom fixture having a surface, the method comprising the steps of:
applying an advertising material to said surface; and
applying a coat of gloss over said advertising material and said surface adjacent said advertising material.

7. The method of claim 6, wherein said advertising material is applied to said surface with an adhesive during the step of applying said advertising material to said surface.

8. The method of claim 6, further comprising the step of:
applying a bonding agent to said surface at least adjacent said advertising material, prior to applying said coat of gloss.

9. The method of claim 6, further comprising the step of:
preparing said surface prior to applying said advertising material.

10. The method of claim 9, wherein said step of preparing said surface comprises:
cleaning said surface with an acidified cleaner; and
degreasing said surface with a silicone wash.

11. The method of claim 6, wherein said gloss comprises:
three parts high gloss clear;
one part catalyst; and
one part thinner.

12. The method of claim 6, further comprising the step of:
applying multiple coats of said gloss over said advertising material and said surface adjacent said advertising material.

13. A method for sequentially displaying different advertisements in a bathroom, comprising the steps of:
placing an advertising material on a surface of a bathroom fixture;
displaying said advertising material for a predetermined amount of time;
removing said fixture from the bathroom and replacing it with a new fixture of the same type; and
determining whether another advertisement will be displayed.

14. The method of claim 13, further comprising the step of:
preparing said surface prior to applying said advertising material.

15. The method of claim 13, wherein said advertising material is placed on said bathroom fixture by applying said advertising material on said surface, applying a bonding agent to said surface at least adjacent said advertising material, and applying a coating of a gloss over said advertising material and said surface adjacent said advertising material.

16. The method of claim 15, wherein multiple coats of said gloss are applied over said advertising material and said surface adjacent said advertising material.

17. The method of claim 13, wherein said advertising material is a plastic-based decal.

18. A method for sequentially displaying different advertisements in a bathroom, comprising the steps of:
placing an advertising material on a surface of a bathroom fixture;
displaying said advertising material for a predetermined amount of time;
removing said advertising material from said surface;
determining whether said surface needs to be prepared for the placement of a subsequent advertising material; and
placing said subsequent advertising material to said surface.

19. The method of claim 18, wherein said advertising material is placed on said bathroom fixture by applying said advertising material on said surface, applying a bonding agent to said surface at least adjacent said advertising material, and applying a coating of a gloss over said advertising material and said surface adjacent said advertising material.

20. The method of claim 18, further comprising the step of:
preparing said surface prior to placing said subsequent advertising material to said surface.

21. The method of claim 18, wherein said advertising material is a plastic-based decal.
